(19) United States
(12) Patent Application Publication
(10) Pub. No.: US 2004/0190968 A1
(43) Pub. Date: Sep. 30, 2004

(54) Keyboard of multi-point multiple common keys

(76) Inventor: Tai-Her Yang, Si-Hu Town (TW)

Correspondence Address: RABIN & BERDO, P.C., Suite 500, 1101 14th Street, N.W., Washington, DC, 20005, US

(21) Appl. No.: 10/395,127

(22) Filed: Mar. 25, 2003

(51) Int. Cl. B41J 5/08

(52) U.S. Cl. 400/472

(57) ABSTRACT

A keyboard of multiple common keys with each common key providing multiple operation points; wherein, the keyboard being provided with three or more than three common keys and each common key, with three or more than three operation points; each point being respectively given with an independent definition; a specific spatial arrangement being provided among all common keys; and each operation point from each common key being available for giving an alphabetic, numeric or phonetic definition.

### BACKGROUND OF THE INVENTION

(a) Field of the Invention

The present invention is related to a keyboard containing function specific multiple common keys each defined with multiple operation points for space saving and providing higher density for manual operation on a limited space.

(b) Description of the Prior Art:

When used as a manual control interface including a cell phone, computer input, or other input control applications, each key provided on the conventional keyboard is usually defined only with a single function, or swift between optional definitions is given to a single key by operating a swift key, followed with the layout of multiple keys to form a keypad. Whereas a keypad is comprised of multiple single keys and minimum spacing for fingertip operation must be taken into consideration, the keypad usually consumes a larger space on the keyboard. So far a single key allowing multi-location operation on a keyboard is available in the market; however, each of all locations on the common key is given its specific definition and its relative signal output, such as that for two-way operation, or cross coordinate location operation, or operation of page turning options, and there is the absence of a design for a keyboard that contains multiple common key to enter alphabetical, numeric or phonetic symbols.

### SUMMARY OF THE INVENTION

The primary purpose of the present invention is to provide a keyboard containing function specific multiple common keys each defined with multiple operation points. Wherein, three or more than three common keys are provided, and each common key is provided with three or more than three operation points with each point independently defined; a specified spacing arrangement is given among each common key, and each operation point on the individual common key is assigned a definition of alphabetical, numeric or phonetic symbol.

### BRIEF DESCRIPTION OF THE DRAWINGS

FIG. 1 is a schematic view showing a keyboard of the present invention containing three or more than three common keys of different types, with each common key providing two or more than two operation points.

FIG. 2 is another schematic view showing the keyboard of the present invention containing three or more than three common keys of different types, with each common key providing two or more than two operation points.

FIG. 3 is a schematic view showing a keyboard of the present invention containing three or more than three common keys with each providing three operation points.

FIG. 4 is a schematic view showing a keyboard of the present invention containing three or more than three common keys with each providing four operation points.

FIG. 5 is a schematic view showing a keyboard of the present invention containing three or more than three common keys with each providing five operation points.

FIG. 6 is a schematic view showing a keyboard of the present invention containing three or more than three common keys with each providing six operation points.

FIG. 7 is a schematic view showing a keyboard of the present invention containing three or more than three common keys with each providing seven operation points.

FIG. 8 is a schematic view showing a keyboard of the present invention containing three or more than three common keys with each providing eight operation points.

FIG. 9 is a schematic view showing a keyboard of the present invention containing three or more than three common keys with each providing nine operation points.

FIG. 10 is a schematic view showing a keyboard of the present invention containing three or more than three triangle common keys with each providing four operation points.

### DETAILED DESCRIPTION OF THE PREFERRED EMBODIMENTS

A keyboard of multiple common keys with each common key providing multiple operation points of the present invention is characterized by that the keyboard is provided with three or more than three common keys and each common key is provided with three or more than three operation points; each point is respectively given with an independent definition; a specific spatial arrangement is provided among all common keys; and each operation point from each common key is available for giving an alphabetic, numeric or phonetic definition.

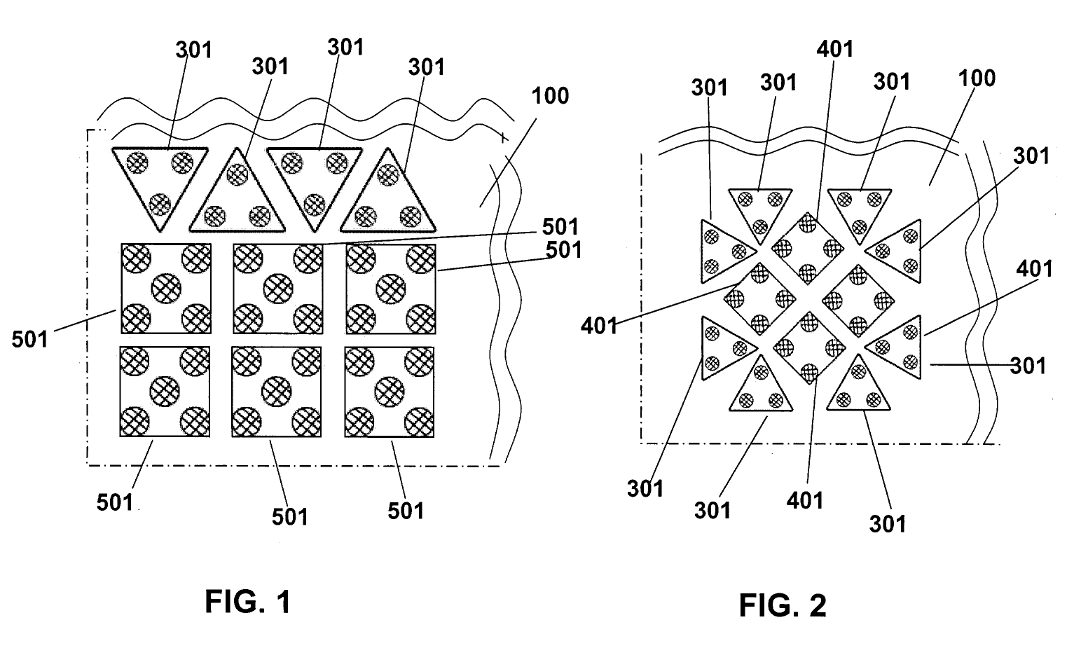

FIGS. 1 and 2 show schematic views of a preferred embodiment of the present invention, wherein, three or more than three common keys with each common key provided with three or more than three operation points, characterized by that:

Three or more than three common keys are provided on the operational panel of a casing 100 of the keyboard; each common key is provided with three or more than operation points (with the location of each point indicated by the shadowed area on each box) and each point is provided with the operational function activated by being pressed, pulled or touched; each operation point creates changes in physical form in relation to the operation status for the output interface circuit to detect and identify for output of individual definition separately given to that operation point;

Each common key may be in the configuration of 2-dimension or 3-dimension and relative location among all the common keys may be selected as desired to form alphabetical, numeric, phonetic or specific function symbols of the definition required to be entered; and related output interface circuit is provided depending on the matching definition or function;

In addition to single keys with each given only one operation points may be also optionally provided on the keyboard, each of three or more than three common keys that allow multiple operational points to be provided on each common key (with the location of each point indicated by the shadowed area on each box) and each point is separately given its independent definition; each common key is provided with three or more than three operation points, and the number of the operational point of each common key may be identical or vary among all the common keys; every operational point on each common key may be independently defined or may execute shift among definitions by operation of the swift key; and during the operation, changes of physical form is created in relation to the operation status to be detected and identified by the output interface circuit so to execute relative output.

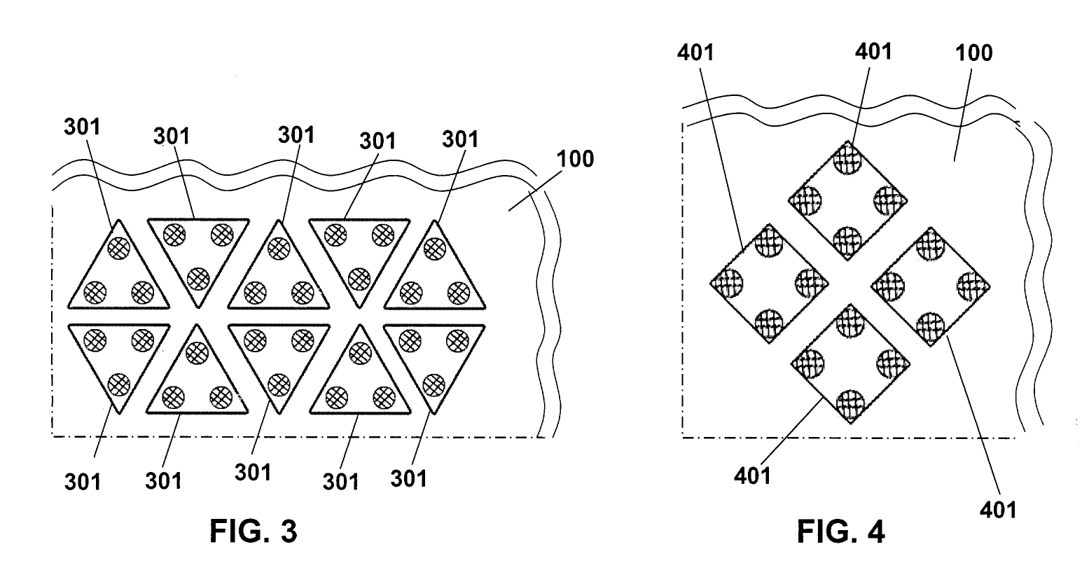

FIG. 3 is a schematic view showing a keyboard of the present invention containing three or more than three common keys with each providing three operation points. Wherein, three or more than three common keys 301 with each provided with three or more than three operation points, and may be combined with additional keys of other types as applicable.

FIG. 4 is a schematic view showing a keyboard of the present invention containing three or more than three common keys with each providing four operation points. Wherein, three or more than three common keys 401 with each provided with four or more than four operation points, and may be combined with additional keys of other types as applicable.

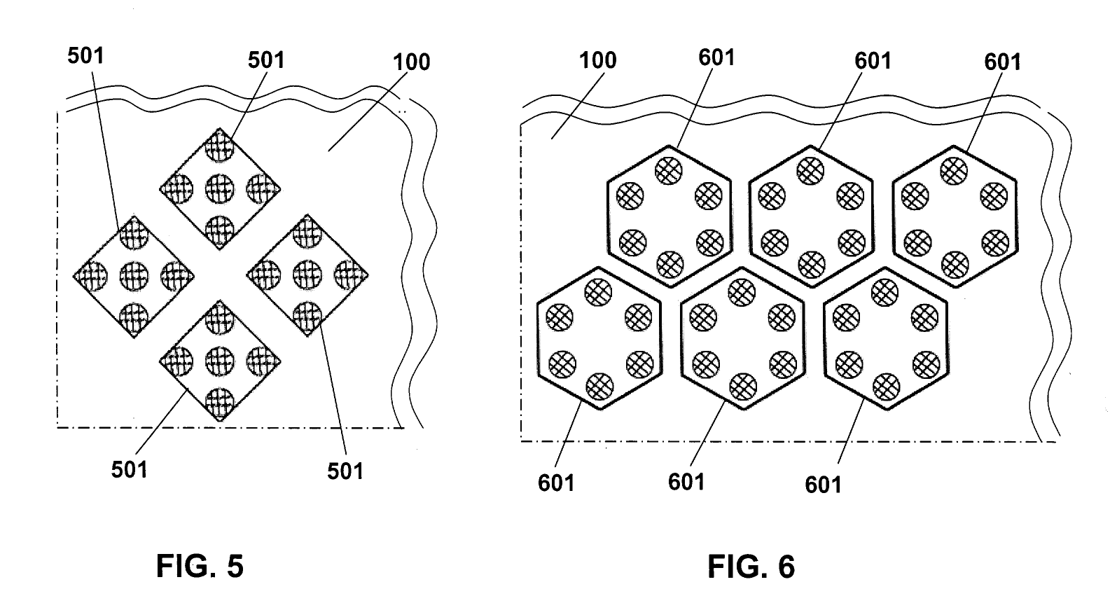

FIG. 5 is a schematic view showing a keyboard of the present invention containing three or more than three common keys with each providing five operation points. Wherein, three or more than five common keys 501 with each provided with five or more than five operation points, and may be combined with additional keys of other types as applicable.

FIG. 6 is a schematic view showing a keyboard of the present invention containing three or more than three common keys with each providing six operation points. Wherein, three or more than three common keys 601 with each provided with six or more than six operation points, and may be combined with additional keys of other types as applicable.

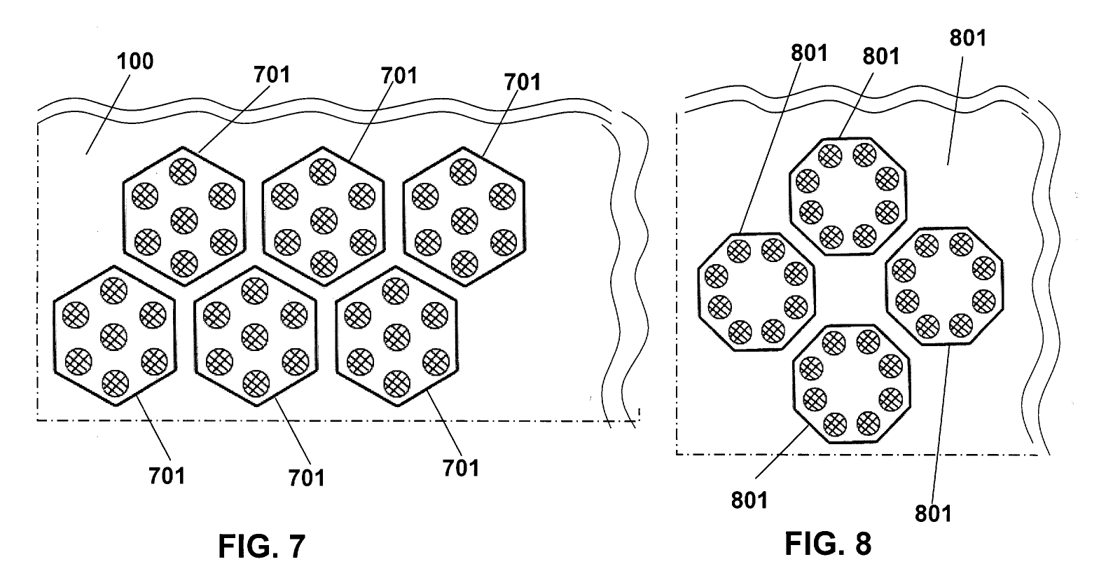

FIG. 7 is a schematic view showing a keyboard of the present invention containing three or more than three common keys with each providing seven operation points. Wherein, three or more than three common keys 701 with each provided with seven or more than seven operation points, and may be combined with additional keys of other types as applicable.

FIG. 8 is a schematic view showing a keyboard of the present invention containing three or more than three common keys with each providing eight operation points. Wherein, three or more than three common keys 801 with each provided with eight or more than eight points, and may be combined with additional keys of other types as applicable.

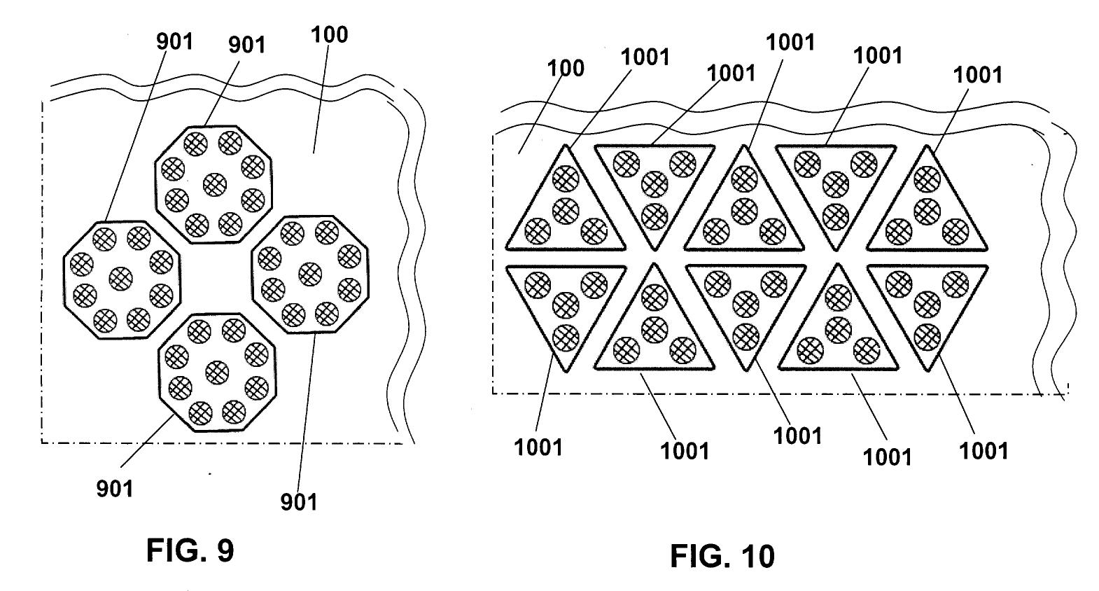

FIG. 9 is a schematic view showing a keyboard of the present invention containing three or more than three common keys with each providing nine operation points. Wherein, three or more than three common keys 901 with each provided with nine or more than nine operation points, and may be combined with additional keys of other types as applicable.

Fig. 10 is a schematic view showing a keyboard of the present invention containing three or more than three triangle common keys with each providing four operation points. Wherein, three or more than three common keys 1001 in triangle, with each provided with four or more than four operation points, and may be combined with additional keys of other types as applicable.

The keyboard containing three or more than three common keys with three or more than three operation points given to each common key of the present invention may be provided in any of the following structures as applicable:

the keyboard being comprised of three ore more than three common keys, each given independent definition and provided with three or more than three operation points; wherein, all the common keys being provided on the same plane where allows multiple points to be pressed or pulled, or any operation point may not be on the same plane as that for the other operation point to be pressed or pulled;

the keyboard being comprised of three ore more than three common keys, each given independent definition and provided with three or more than three operation points; wherein, all the common keys being arranged on a flat plane or in slightly arc, or on different slopes;

the keyboard being comprised of three ore more than three common keys, each given independent definition and provided with three or more than three operation points; wherein, any common key provided with three or more than three optional keys further containing a conventional resistance, capacitor, induction, or static type of analogy, digital, on/off, or sensor, or optical operation status detect device, so to detect the relative operation status upon the operation point of the common key being operated to generate and deliver signals to the output interface circuit;

the keyboard being comprised of three ore more than three common keys, each given independent definition and provided with three or more than three operation points; wherein, all the common keys being symmetrically or a symmetrically arranged;

the keyboard being comprised of three ore more than three common keys, each given independent definition and provided with three or more than three operation points; wherein, the number of operation point may vary among all the common keys;

the keyboard being comprised of three ore more than three common keys, each given independent definition and provided with three or more than three operation points; wherein, all the common keys may be provided in the same shape or different shapes;

the keyboard being comprised of three ore more than three common keys, each given independent definition and provided with three or more than three operation points; wherein, all the common keys may be provided in the same size or different sizes;

the keyboard being comprised of three ore more than three common keys, each given independent definition and provided with three or more than three operation points; wherein, four corners of a common key in an approximately quadrangle, so that when each corner is operated, a change of physical status in relation to the operation status is created for the output interface circuit to detect and identify;

the keyboard being comprised of three ore more than three common keys, each given independent definition and provided with three or more than three operation points; wherein, four corners of a common key in an approximately quadrangle, so that when each corner is operated, a change of physical status in relation to the operation status is created for the output interface circuit to detect and identify; and the central location of the common key is provided as the fifth operation point to create a change of physical status in relation to the operation status for the output interface circuit to detect and identify;

the keyboard being provided with three or more than three common keys and each common key, with three or more than three operation points; and is provided in the structure that all the common keys are arranged such that the vertical side-to-side axial line of each common key is at a selected angle to the operation side.

the keyboard being provided with three or more than three common keys and each common key, with three or more than three operation points; and is provided in the structure that all the common keys are arranged such that the corner-to-corner axial line of each common key is at a selected angle to the operation side.

the central operation area of each keyboard provided with multiple common keys may be further provided with indicator or display as applicable.

The keyboard being provided with three or more than three common keys and each common key, with three or more than three operation points; and is provided in the structure that for seismic, waterproof, or purely visual engineering consideration, a hard or soft cover may be provided to cover up each common key; and the cover may be opaque or transparent and printed with relative definition symbols including alphabetical, numeric or phonetic symbol.

The present invention for providing three or more than three common keys with each common key provided with three or more than three operation points and each operation point being independently defined to save space without compromising its convenience is innovative; therefore, this application is duly filed.

1. A keyboard of multiple common keys with each common key providing multiple operation points; wherein, the keyboard being provided with three or more than three common keys and each common key, with three or more than three operation points; each point being respectively given with an independent definition; a specific spatial arrangement being provided among all common keys; and each operation point from each common key being available for giving an alphabetic, numeric or phonetic definition characterized by that:
three or more than three common keys are provided on the operational panel of a casing 100 of the keyboard; each common key is provided with three or more than operation points (with the location of each point indicated by the shadowed area on each box) and each point is provided with the operational function activated by being pressed, pulled or touched; each operation point creates changes in physical form in relation to the operation status for the output interface circuit to detect and identify for output of individual definition separately given to that operation point;
each common key may be in the configuration of 2-dimension or 3-dimension and relative location among all the common keys may be selected as desired to form alphabetical, numeric, phonetic or specific function symbols of the definition required to be entered; and related output interface circuit is provided depending on the matching definition or function;
in addition to single keys with each given only one operation points may be also optionally provided on the keyboard, each of three or more than three common keys that allow multiple operational points to be provided on each common key (with the location of each point indicated by the shadowed area on each box) and each point is separately given its independent definition; each common key is provided with three or more than three operation points, and the number of the operational point of each common key may be identical or vary among all the common keys; every operational point on each common key may be independently defined or may execute shift among definitions by operation of the swift key; and during the operation, changes of physical form is created in relation to the operation status to be detected and identified by the output interface circuit so to execute relative output.

2. A keyboard of multiple common keys with each common key providing multiple operation points as claimed in claim 1; wherein, the keyboard being provided with three or more than three common keys and each common key, with three or more than three operation points; and may be provided in the structure that the keyboard being comprised of three ore more than three common keys, each given independent definition and provided with three or more than three operation points; wherein, all the common keys being provided on the same plane where allows multiple points to be pressed or pulled, or any operation point may not be on the same plane as that for the other operation point to be pressed or pulled;

3. A keyboard of multiple common keys with each common key providing multiple operation points as claimed in claim 1; wherein, the keyboard being provided with three or more than three common keys and each common key, with three or more than three operation points; and is provided in the structure that all the common keys being arranged on a flat plane or in slightly arc, or on different slopes.

4. A keyboard of multiple common keys with each common key providing multiple operation points as claimed in claim 1; wherein, the keyboard being provided with three or more than three common keys and each common key, with three or more than three operation points; and is provided in the structure that any common key provided with three or more than three optional keys further containing a conventional resistance, capacitor, induction, or static type of analogy, digital, on/off, or sensor, or optical operation status detect device, so to detect the relative operation status upon the operation point of the common key being operated to generate and deliver signals to the output interface circuit.

5. A keyboard of multiple common keys with each common key providing multiple operation points as claimed in claim 1; wherein, the keyboard being provided with three or more than three common keys and each common key, with three or more than three operation points; and is provided in the structure that all the common keys being symmetrically or a symmetrically arranged.

6. A keyboard of multiple common keys with each common key providing multiple operation points as claimed in claim 1; wherein, the keyboard being provided with three or more than three common keys and each common key, with three or more than three operation points; and is provided in the structure that the number of operation point may vary among all the common keys.

7. A keyboard of multiple common keys with each common key providing multiple operation points as claimed in claim 1; wherein, the keyboard being provided with three or more than three common keys and each common key, with three or more than three operation points; and is provided in the structure that all the common keys may be provided in the same shape or different shapes.

8. A keyboard of multiple common keys with each common key providing multiple operation points as claimed in claim 1; wherein, the keyboard being provided with three or more than three common keys and each common key, with three or more than three operation points; and is provided in the structure that all the common keys may be provided in the same size or different sizes.

9. A keyboard of multiple common keys with each common key providing multiple operation points as claimed in claim 1; wherein, the keyboard being provided with three or more than three common keys and each common key, with three or more than three operation points; and is provided in the structure that four corners of a common key in an approximately quadrangle, so that when each corner is operated, a change of physical status in relation to the operation status is created for the output interface circuit to detect and identify.

10. A keyboard of multiple common keys with each common key providing multiple operation points as claimed in claim 1; wherein, the keyboard being provided with three or more than three common keys and each common key, with three or more than three operation points; and is provided in the structure that four corners of a common key in an approximately quadrangle, so that when each corner is operated, a change of physical status in relation to the operation status is created for the output interface circuit to detect and identify; and the central location of the common key is provided as the fifth operation point to create a change of physical status in relation to the operation status for the output interface circuit to detect and identify.

11. A keyboard of multiple common keys with each common key providing multiple operation points as claimed in claim 1; wherein, the keyboard being provided with three or more than three common keys and each common key, with three or more than three operation points; and is provided in the structure that all the common keys are arranged such that the vertical side-to-side axial line of each common key is at a selected angle to the operation side.

12. A keyboard of multiple common keys with each common key providing multiple operation points as claimed in claim 1; wherein, the keyboard being provided with three or more than three common keys and each common key, with three or more than three operation points; and is provided in the structure that all the common keys are arranged such that the corner-to-corner axial line of each common key is at a selected angle to the operation side.

13. A keyboard of multiple common keys with each common key providing multiple operation points as claimed in claim 1; wherein, the keyboard being provided with three or more than three common keys and each common key, with three or more than three operation points; and is provided in the structure that the central operation area of each keyboard provided with multiple common keys may be further provided with indicator or display as applicable.

14. A keyboard of multiple common keys with each common key providing multiple operation points as claimed in claim 1; wherein, the keyboard being provided with three or more than three common keys and each common key, with three or more than three operation points; and is provided in the structure that for seismic, waterproof, or purely visual engineering consideration, a hard or soft cover may be provided to cover up each common key; and the cover may be opaque or transparent and printed with relative definition symbols including alphabetical, numeric or phonetic symbol.
